(19) United States
(12) Patent Application Publication
(10) Pub. No.: US 2003/0189051 A1
(43) Pub. Date: Oct. 9, 2003

(54) Cap for a radiator of a car

(76) Inventor: Lai-Chen Liu, Taiping City (TW)

Correspondence Address: VARNDELL & VARNDELL, PLLC, 106-A S. COLUMBUS ST., ALEXANDRIA, VA, 22314, US

(21) Appl. No.: 10/118,352

(22) Filed: Apr. 9, 2002

(51) Int. Cl. G01M 3/04; B65D 51/16

(52) U.S. Cl. 220/303; 220/DIG. 32; 73/45.8; 73/49.7

(57) ABSTRACT

A cap for a vehicle radiator has a body, a sealing member, a biasing member and a connector. The body is detachably mounted on the mouth of the radiator. A protrusion with a central hole is mounted on the body. The sealing member is slidably attached to the body for sealing the opening in the radiator and has a flange, a seal and a stub. The stub extends upward from the top of the flange and extends through the central hole in the protrusion on the body. The outer periphery of the stub contacts with the inner surface of the central hole in the body. Accordingly, the stub can be securely held on the body to prevent a gap being defined between the seal and the opening. This gap prevention can avoid leak between the sealing member and the mouth occurring during the leak-detecting process of the radiator.

### BACKGROUND OF THE INVENTION

1. Field of the Invention

The present invention relates to a cap, and more particularly to a cap for a tank of a car and that can be connected to a leak-detecting device.

2. Description of Related Art

To avoid the engine of a car overheating, a cooling system is necessary in the car. The cooling system in the car is based on a radiator containing water and a tunnel leading from and to the radiator. Cool water is pumped from the radiator and along the tunnel which has a route through the cylinder block of the engine. Heat generated by the engine is dissipated into the water flow and the heated water flows back to the radiator which is cooled by air passing through it as the car is in motion. To ensure the cooling system has a good performance, the water in the radiator must be keep above a desired level otherwise the engine may overheat and suffer serious damage. Thus, it is important that leaks are prevented, or at least detected early so that the driver can take appropriate action. A cap adapted to receive a leak-detecting device is fitted to the radiator so that the driver can quickly determine if there is a leak and how serious it may be. With reference to FIGS. 4 and 5, the cap (50) for a radiator (30) in accordance with the prior art comprises a body (500), a sealing member (51), a biasing member (55) and a connector (56). The body (500) is detachably mounted on a mouth (31) with an opening (32) in the radiator (30), and a through hole (502) is defined through the body (500). The sealing member (51) is slidably mounted on the body (500) and adapted for sealing the opening (32) in the radiator (30). The sealing member (51) has a flange (52), a seal (53) and a stub (54). The seal (53) is mounted below the flange (52) and is adapted for sealing the opening (32) in the mouth (31) in the radiator (30). The stub (54) extends upward from the top of the flange (52) and extends through the through hole (502) in the body (500). A threaded portion (not numbered) is formed on the outer periphery of the top of the stub (54). A passage (not numbered) is defined through the stub (54) and the flange (52) to communicate with the opening (32) in the radiator (30). The biasing member (55) is a spring and which is mounted around the stub (54). Two ends of the spring respectively abut the flange (52) and the bottom of the body (500). The connector (56) is screwed with the threaded portion on the stub (54). With the connector (56), the cap (50) can be connected to a leak-detecting device. The leak detecting device comprises an air pump (40) and a pressure meter (41). The meter (41) is mounted on the air pump (40). A hose (43) is connected to the air pump (40), and a connector (42) is mounted on the hose (43) to couple with the connector (56) on the cap (50).

With such a leak-detecting device, the air can be pumped into the radiator (30) through the hose (43), the connectors (42,56), the passage in the cap (50) and the opening (32) in the radiator (30). If the pressure detected by the pressure meter (41) is continuously reduced, it means that there is a rupture in the radiator system and water will leak from the system.

However, because the body (500) of the conventional cap (50) is flat, the inner surface of the through hole (502) for contacting with the stub (54) is very small. Therefore, the stub (54) on the sealing member (51) cannot be securely held on the body (500). If a lateral force is applied to the connector (56), the sealing member (51) will be moved relative to the mouth (31) of the radiator (30). A gap will be defined between the seal (53) and the opening (32) due to the movement of the sealing member (51), and the air pumped into the radiator will escape through the gap. This will cause a misleading detection result.

To overcome the shortcomings, the present invention tends to provide a cap to mitigate or obviate the aforementioned problems.

### SUMMARY OF THE INVENTION

The main objective of the invention is to provide a cap for a radiator and that can keep effectively and continuously seal the opening of the radiator during the leak-detection process. The cap has a body, a sealing member, a biasing member and a connector. The body is detachably mounted on the mouth of the radiator. A protrusion with a central hole is mounted on the body. The sealing member is slidably attached to the body for sealing the opening in the radiator and has a flange, a seal and a stub. The stub extends upward from the top of the flange and extends through the central hole in the protrusion on the body. The outer periphery of the stub contacts with the inner surface of the central hole in the body. Accordingly, the stub can be securely held on the body to prevent a gap being defined between the seal and the opening even when a lateral force is applied to the connector. This can avoid leaks between the sealing member and the mouth occurring during the leak-detecting process to the tank.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a cap in accordance with the present invention;

FIG. 2 is an exploded perspective view of the cap in FIG. 1 with the leak detecting device and the radiator of a car;

FIG. 3 is a side plan view in partial cross section of the cap in FIG. 1 with the radiator of a car;

FIG. 4 is an exploded perspective view of a leak detecting device and a radiator of a car with a conventional cap in accordance with the prior art; and

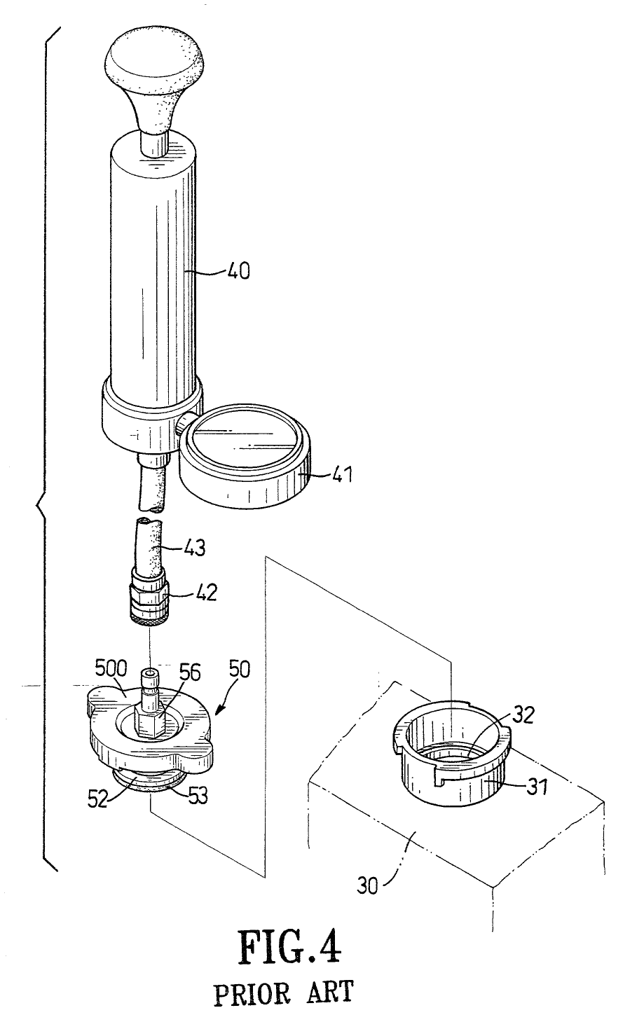

FIG. 5 is a side plan view in partial cross section of the radiator with the conventional cap in FIG. 4.

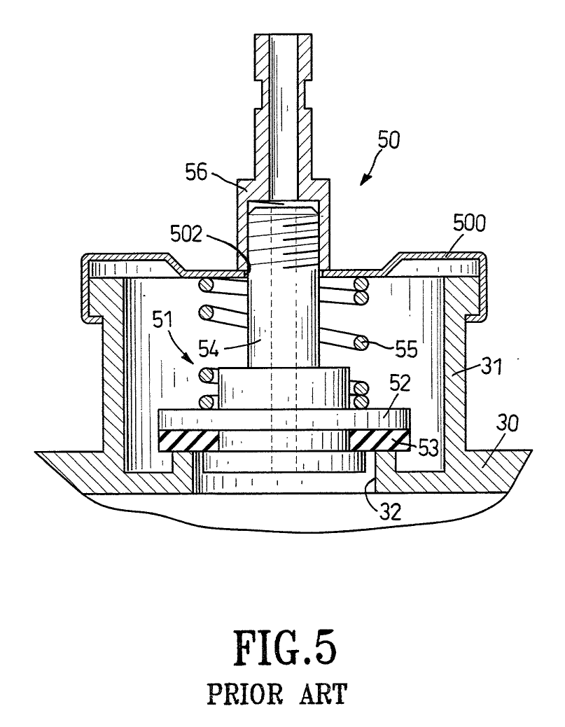

### DETAILED DESCRIPTION OF PREFERRED EMBODIMENT

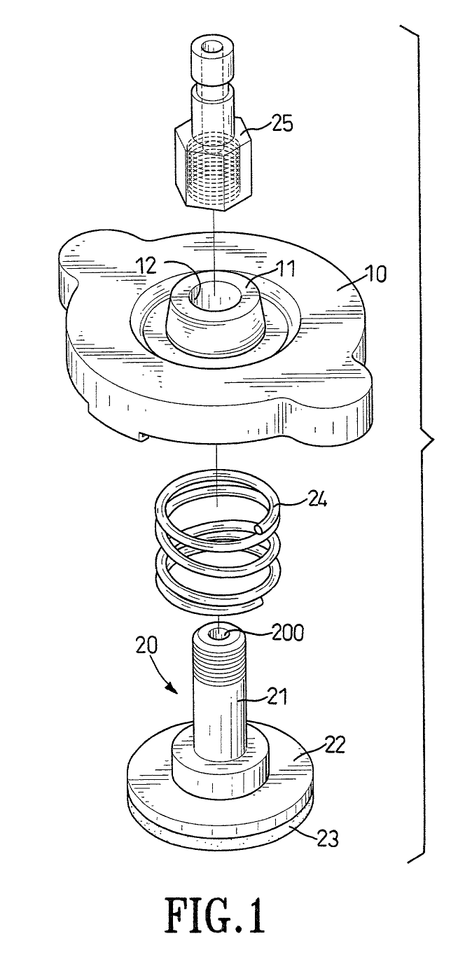

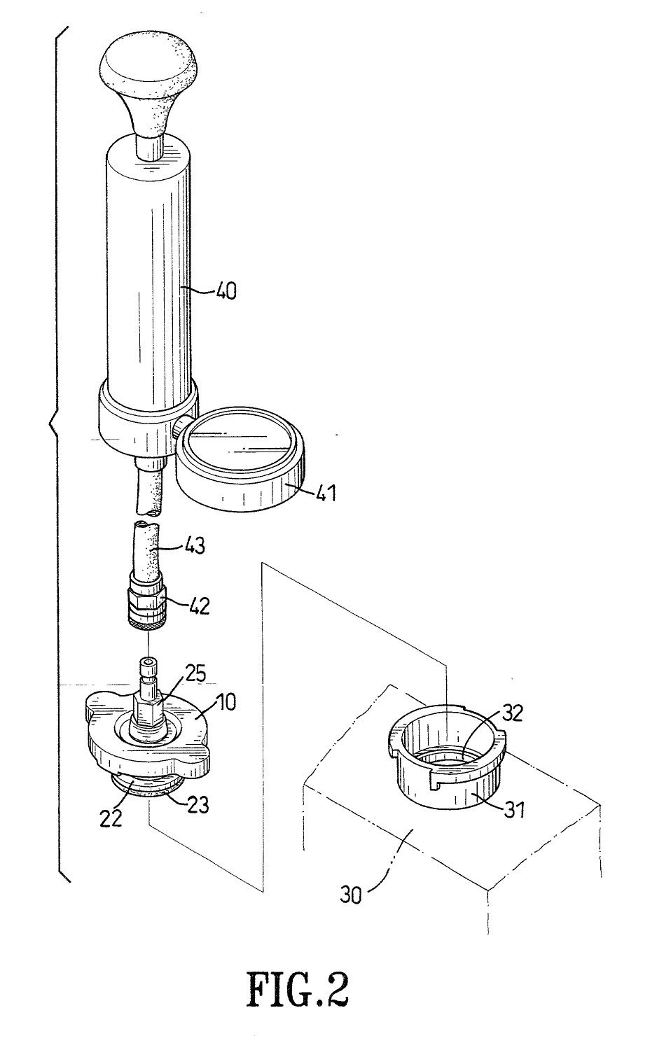

With reference to FIGS. 1 and 2, a cap for a radiator (30) of a car in accordance with the present invention comprises a body (10), a sealing member (20), a biasing member (24) and a connector (25). The body (10) is detachably mounted on a mouth (31) with an opening (32) in the radiator (30). A through hole (not numbered) is defined in a central position of the body (10). A protrusion (11) is securely attached into the through hole in the body (10), and a central hole (12) is defined through the protrusion (11). In practice, the protrusion (11) is a separate structure being secured to the top of the body (10) by welding.

The sealing member (20) is slidably mounted on the body (10) and is adapted for sealing the opening (32) in the radiator (30). The sealing member (20) comprises a flange (22), a seal (23) and a stub (21). The seal (23) is mounted to the bottom of the flange (22) and is adapted for sealing the opening (32) in the mouth (31) in the radiator (30). The stub (21) extends upward from the top of the flange (22) and extends through the central hole (12) in the protrusion (11) on the body (10). The outer periphery of the stub (21) contacts with the inner surface of the central hole (12) in the body (10). A passage (200) is defined through the stub (21) and the flange (22) to communicate with the opening (32) in the radiator (30). A threaded portion (not numbered) is formed on the outer periphery of the top of the stub (21).

The biasing member (24) is mounted around the stub (21). Two ends of the biasing member (24) respectively abut the flange (22) and the bottom of the body (10), such that the biasing member (24) can provide a force to push the flange (22) so as to push the seal (23) to exactly seal the opening (32). In practice, the biasing member (24) is a compression coil spring.

The connector (25) is attached to the top of the stub (21). An inner threaded portion (not numbered) is defined in the bottom of the connector (25) to screw with the threaded portion on the stub (21). With the connector (25), the sealing member (21) can be connected to a leak-detecting device for detecting a leak condition of the radiator (30). The detecting device has an air pump (40), a pressure meter (41), a hose (43) and a connector (42).

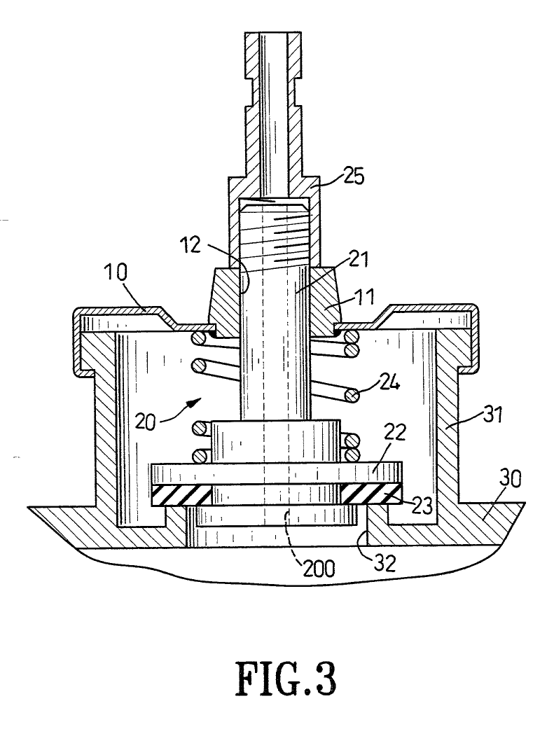

With reference to FIGS. 2 and 3, because the inner surface of the through hole (12) in the protrusion (11) contacts with the outer periphery of the stub (21), the contacting area between the stub (21) and the body (10) is large whereby the body (10) can securely hold the stub (21). The protrusion (11) on the body (10) can keep the stub (21) from laterally moving relative to the body (10), such that the seal (23) will not leave a position of sealing the opening (32) in the radiator (30) even when a lateral force is applied to the connector (25). This can keep a gap from being defined between the seal (23) and the opening (32), and the air pumped from the air pump (40) of the leak detecting device into the radiator (30) will not escape, such that no misleading information will occur. Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the fill extent indicated by the broad general meaning of the terms in which the appended claims are expressed.

What is claimed is:

1. A cap for a radiator of a car comprising:
a body adapted to be detachably mounted on a mouth with an opening in the radiator and having a protrusion mounted on the body and a central hole defined through the protrusion and the body;
a sealing member slidably mounted on the body and adapted for sealing the opening in the radiator, the sealing member having:
a flange;
a seal mounted to a bottom of the flange and adapted for sealing the opening in the mouth in the radiator; a stub extending upward from a top of the flange and extending through the central hole in the protrusion on the body, the stub having an outer periphery abutting an inner surface of the central hole in the body; and
a passage defined through the stub and the flange to communicate with the opening in the radiator;
a biasing member mounted around the stub and having two ends respectively abutting the flange and a bottom of the body; and
a connector attached to a top of the stub and adapted for be connected to a leak detecting device for detecting a leak condition of the radiator.

2. The cap as claimed in claim 1, wherein the stub has a threaded portion formed on an outer periphery of a top of the stub; and
the connector has an inner threaded portion in a bottom of the connector to screw with the threaded portion on the stub.

3. The cap as claimed in claim 1, wherein the protrusion is a separate structure being secured to the top of the body by a welding process.

4. The cap as claimed in claim 1, wherein the biasing member is a spring.
